(19) United States
(12) Patent Application Publication
(10) Pub. No.: US 2008/0094396 A1
(43) Pub. Date: Apr. 24, 2008

(54) System For The Three-Dimensional Imaging Of A Moving Joint

(75) Inventors: Joerg Sabczynsdi, Norderstedt (DE); Geert Streekstra, Amsterdam (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/574,748

(22) PCT Filed: Sep. 2, 2005
(86) PCT No.: PCT/IB05/52882

§ 371 Date: Mar. 6, 2007

(30) Foreign Application Priority Data
Sep. 9, 2004 (EP) 04300586.7

(51) Int. Cl. G06K 9/00; G06T 17/00

(52) U.S. Cl. 345/424; 382/132

(57) ABSTRACT

The invention relates to a system and a method for the generation of 3D images of a moving joint (1). A rotational X-ray device (10) generates projections of said joint from different directions while the simultaneous periodic movement of the joint (1) is recorded by a monitoring device (20). The generated X-ray projections are then classified according to the phase of joint movement to which they belong, and 3D images are reconstructed from X-ray projections of each class. Thus a 3D movie of the joint movement can be produced and shown on a monitor. The monitoring device (20) may particularly be realized by an apparatus that allows the forced movement of the joint (1) in synchronization with the generation of X-ray projections.

### FIELD OF THE INVENTION

The invention relates to a system and a method for the generation of three-dimensional images of a joint in different phases of its motion.

### BACKGROUND OF THE INVENTION

X-ray images are an important tool for the analysis and diagnosis of the (mal-)function of body joints. For an investigation of the movement of the knee it was proposed in literature to generate a three-dimensional (3D) model of the joint by computer tomography (CT) first and then to record a joint movement by X-ray projections taken simultaneously from two different directions (B. You, P. Siy, W. Anderst, S. Tashman: “In Vivo Measurement of 3-D Skeletal Kinematics from Sequences of Biplane Radiographs: Application to Knee Kinematics”, IEEE Transactions on Medical Imaging, pp. 514-525 (2001)). Parameters derived from said X-ray projections are used in this approach as input to the 3D joint model for the generation of a 3D movie. The actual joint movement may however differ substantially from such a movie because the latter relies on a plurality of assumptions and because positional errors are introduced by the registration of 2D projections with 3D representations.

### SUMMARY OF THE INVENTION

Based on this situation it was an object of the present invention to provide means for an accurate and highly informative analysis of joint movements.

This object is achieved by a system according to claim 1 and a method according to claim 8. Preferred embodiments are disclosed in the dependent claims.

According to a first aspect, the invention relates to a system for the generation of three-dimensional (3D) images of a joint in different phases of its motion. Here and in the following, the term “joint” shall comprise body joints like knee, wrist, elbow, or shoulder as well as in general body structures with movable components (particularly bones), e.g. the spinal column. Moreover, the term “motion of a joint” shall refer to the internal movement of the joint only, i.e. the movement (rotation, translation, deformation) of its components (bones, cartilage etc.) relative to each other, and not to a translation of the joint as a whole. In the most simple or simplified case, a “joint motion” may be described by a single angle of flexion/extension. The system comprises the following main components:

a) A rotational X-ray device that is by definition adapted to generate a series of projections of the joint from different directions. Moreover, the X-ray device shall be adapted to generate said projections while the joint is moving, e.g. periodically flexed and extended. The rotational X-ray device may particularly be a so-called C-arm system wherein an X-ray source and an X-ray detector are fixed at different ends of a semicircular bow which can be rotated about a central axis or point. Due to the movement of the joint, the generated series of projections comprises projections that capture different phases of the joint movement.

b) A monitoring device that is adapted to provide information on the current motion phase of the joint during its movement and during the generation of X-ray projections. Said motion phase may particularly be characterized by one or more angles enclosed between different bones of the joint. The monitoring device optionally generates an analog or digital signal that represents a currently measured motion phase of the joint. The monitoring device may alternatively force a predetermined movement on the joint and provide information on the current motion phase in an “open loop” way.

c) An image processing device, for example a digital computer, for subdividing a series of projections of the aforementioned kind into different classes or sets of projections, wherein the projections of one class correspond to (approximately) the same motion phase of the joint and wherein said motion phases are distinct for the different classes. Moreover, the image processing device is adapted to reconstruct for each such class a three-dimensional image from the projections contained in said class. Said 3D images therefore show the joint in different phases of its motion.

The system described above has the advantage that it allows the generation of a 3D film sequence of the joint movement which has a high correlation to the actual movement because it is based on real 3D images of the joint. Moreover, the generation of such a movie is possible with a rotational X-ray device which is already present as a standard equipment in many medical laboratories.

A monitoring device that provides information on the current joint phase may be realized in many different ways. According to a first possibility, the monitoring device comprises a position measuring system that is adapted to determine the spatial position and/or orientation of at least two markers, wherein said markers are disposed on different segments of the joint and wherein the term “marker” shall also comprise systems with several components, e.g. an arrangement of three or more LEDs. Measuring systems that are suited for this purpose are available in many forms. They may for example be based on electromagnetic measurements, wherein magnetic field sensors are used as markers on the joint which measure a temporarily and spatially inhomogeneous magnetic field. The position measuring system may also be an optical system, wherein for example the position of luminescent LEDs on the joint is determined by video cameras at different positions in space according to the principles of stereoscopy.

According to another embodiment, the monitoring device comprises at least one goniometer that can be attached to the joint and measure an angle, for example the angle between two segments of the joint. Depending on the kind of joint that shall be observed, the goniometer can be adapted to measure angles with one or more degrees of freedom. Goniometers typically measure the bending (strain) of flexible strips that are attached to the joint and follow its flexion.

The monitoring device may further be realized by an imaging device for generating images of the joint and by a corresponding evaluation unit for deriving the motion phase of the joint from said images. The imaging device may for example be a video camera. Preferably, however, the imaging device is identical to the rotational X-ray device of the system, the images generated with this device being the X-ray projections from different directions. This means that the current phase of joint motion is derived from the X-ray projections themselves by appropriate algorithms of digital image analysis.

The aforementioned embodiments of the monitoring device provide information on the current joint motion phase by measuring it. According to another embodiment, the monitoring device comprises an apparatus that is adapted to force an externally prescribed movement on the joint. Said apparatus may for example comprise a static and a movable support which are connected by a link, wherein the movable support can be periodically pivoted with respect to the static support by some motor device. If then two segments of a joint, for example upper arm and forearm, are placed on the different supports, the corresponding joint will follow the prescribed movement of the supports (provided that the force of the apparatus is strong enough). A monitoring device of this kind has the advantage that the movement of the joint can be externally prescribed and must not the generated by the patients themselves. This guarantees a high accuracy and reproducibility of the movement with selectable parameters (for example frequency). Moreover, the investigation can be made even if the patient is unconscious or the respective joint is paralyzed. The monitoring device provides information on the current motion phase of the joint implicitly (without measurements) by guaranteeing that a known movement with e.g. a prescribed frequency is carried out.

In a preferred embodiment of the invention, the system is adapted such that the movement of the joint is synchronized with the generation of projections by the X-ray device. In particular, the frequency of the generation of X-ray projections may be an integer multiple of the frequency of a periodic joint movement. Such a synchronization guarantees that a plurality of X-ray projections is generated for the same relative phases of the joint movement. The reconstruction of 3D images for such phases is then possible with high accuracy. The synchronization of joint movement and image generation may for example be achieved by prompting an X-ray projection each time a certain motion phase of the joint is passed. Moreover a synchronization may readily be achieved if an apparatus of the aforementioned kind for a forced external movement of the joint is used.

The system may optionally comprise a display unit, for example a monitor, for displaying the reconstructed 3D images. Said display may particularly be adapted to display film sequences of a joint movement on a selectable timescale (e.g. in slow motion). In diagnosis valuable information may be obtained from such movement sequences which is not available from merely static X-ray images.

The invention further relates to a method for the generation of 3D images of a joint in different phases of its motion, comprising the following steps:

a) moving the joint (e.g. for one sweep, periodically etc.);

b) generating a series of X-ray projections of the joint during its movement, said projections being taken from different directions;

c) determining the current phase of the joint motion during the generation of X-ray projections in step b);

d) classifying the projections of the series into classes that correspond to different determined motion phases of the joint and reconstructing 3D images from the projections of each class.

The method comprises in general form the steps that can be executed with a system of the kind described above. Therefore, reference is made to the preceding description for more information on the details, advantages and improvements of that method.

According to a preferred embodiment of the method, the joint is actively moved in synchronization with the generation of X-ray projections. An active movement of the joint guarantees a high accuracy and reproducibility of its movement, whereas the synchronization of joint movement and X-ray projections guarantees a repeated imaging of the same phases of joint movement.

In another embodiment of the method, the current phase of the joint motion is derived from the X-ray projections that are used for the reconstruction of the 3D images. In this case no further device for the determination of joint motion is necessary.

These and other aspects of the invention will be apparent from and elucidated with reference to the embodiment(s) described hereinafter.

### BRIEF DESCRIPTION OF THE DRAWINGS

In the following the invention is described by way of example with the help of the accompanying drawings in which:

FIG. 1 schematically depicts a system according to the present invention for the generation of 3D images of a joint movement;

FIG. 2 schematically depicts an apparatus for a forced movement of a wrist joint;

FIG. 3 shows the temporal course of a joint angle, of the rotational angle of an X-ray device and of the generation of X-ray projections.

### DESCRIPTION OF PREFERRED EMBODIMENTS

Proper functioning of the wrist joint is essential in performing manual tasks ranging from personal care activities to computer related tasks. In case of a malfunctioning wrist it is of major importance for the patient and the doctor to recognize and properly diagnose problems in the wrist at an early stage. To judge wrist function the analysis of 3D patterns of movement of the carpal bones in the wrist joint are crucial. Current 3D imaging methods allow static detection of carpal bone positions and orientations. State of the art detection of 3D carpal bone positions and orientations at multiple poses of the hand can provide for an animated movement pattern only. However, from 2D video radiographic observations it is known that clinically significant abrupt changes in orientation and position of carpal bones can occur. These abrupt changes cannot be detected from the limited number of poses that can be achieved with a 3D static imaging method. Moreover, a real time dynamic movement pattern of carpal bones may deviate from its animated counterpart due to neuromuscular control and dynamic properties of ligaments and cartilage in the wrist.

In the following a method for 4D imaging of the wrist with a modified mobile C-arm system is described. The method is called 4 dimensional rotational X-ray (4D-RX), because 3D rotational X-ray is used to make a series of time resolved reconstructions. To this end a cyclic moving wrist is imaged. Synchronizing the projections used for reconstruction and the wrist cycle yields a number of volume reconstructions of the wrist motion in different phases.

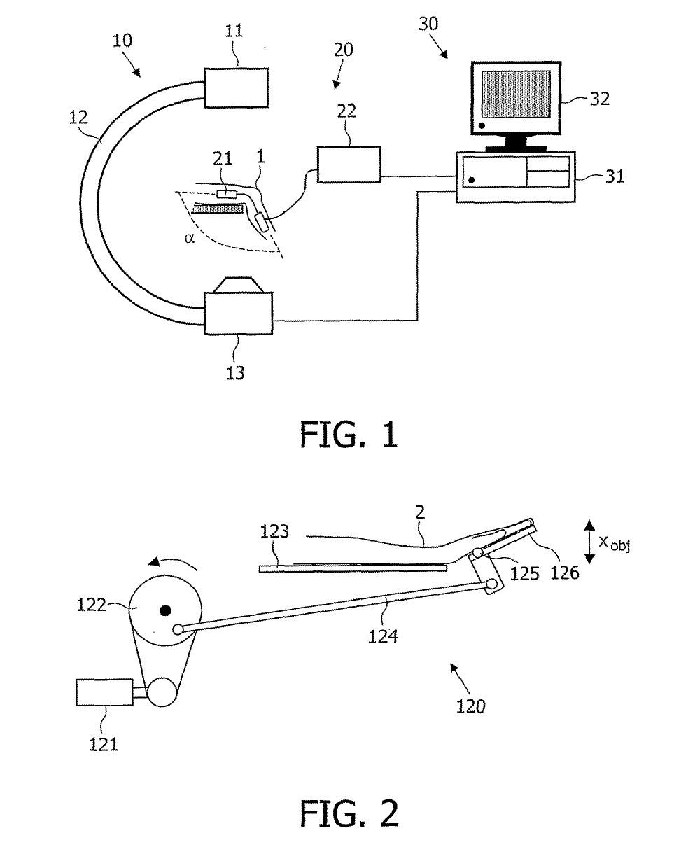

FIG. 1 shows a principal sketch of a system according to the present invention that can be used for the aforementioned imaging of joint movements in three dimensions. The system comprises a rotational X-ray device 10 with an X-ray detector 11 and an X-ray source 13 attached to the ends of a C-arm 12 that can be rotated about a central axis. The joint 1 of a patient is positioned in the centre of said X-ray device 10 such that it is in the field of view during the whole sweep of the X-ray device.

Moreover, the system comprises a monitoring device 20 for measuring the current angle α of the joint 1. In the system of FIG. 1, said monitoring device is realized by a goniometer 21 that is attached to the two segments of the joint 1 to follow the flexion of the joint. The goniometer 21 is connected to a flexion measurement system 22 that generates a signal corresponding to the joint angle α and transmits this signal to a computer or medical workstation 31.

The medical workstation 31 is part of an image processing device 30 and also connected to the X-ray device 10. The computer 31 comprises the usual components like CPU, memory, I/O interfaces etc. Moreover, it is equipped with appropriate software for evaluating the data received from the monitoring device 20 and the X-ray device 10. The image processing device 30 further comprises a monitor 32 for the display of projections and/or of reconstructed 3D images of the joint 1.

In the following, the application of the system of FIG. 1 is described in more detail.

In a conventional 3D-RX system, a mobile C-arm makes a number of X-ray projections over a semicircular track. The pulsed images acquired at constant frequency are sent to the 3D-RX workstation. The projections, corrected for image and geometry distortions, are then reconstructed to a 3D data set, similar to CT (for details see e.g. Grass M., Koppe R., Klotz E., Proksa R., Kuhn M. H., Aerts H., Op de Beek J., Kemkers R.: “Three-dimensional reconstruction of high contrast objects using C-arm image intensifier projection data”, Comput. Med Imaging Graph. 23(6):311-21, 1999).

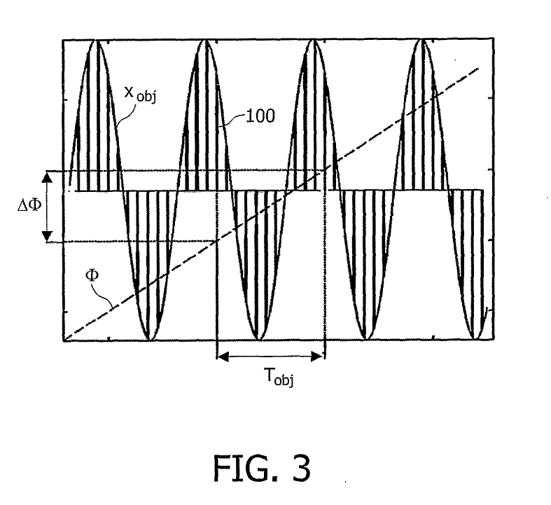

Now the method of making dynamic 3D images with a mobile 3D-RX system 10 is described. To this end the mobile C-arm 12 is rotated around an object (joint 1) that moves periodically with frequency f_{obj}. While rotating, X-ray projections are acquired with the moving joint 1 in the centre of rotation. The acquisition of projections is done with a preset frequency f_{X-ray}. The total number of projections must be a integer multiple of the number of phases within one cycle of the joint motion. Therefore the frequency of the cyclic object motion x_{obj}(t) and the acquisition frequency f_{X-ray} of the X-ray system are synchronized. This can be seen from FIG. 3 which shows the temporal courses of the joint motion x_{obj}(t) (frequency f_{obj}=1/T_{obj}), the rotational angle Φ of the C-arm 12, and the time points 100 at which projections are generated. The number of phases available for reconstruction is then:

$${n}_{phases} = \frac{{f}_{X \text{-} ray}}{{f}_{obj}} \qquad ( 1 )$$

The projections belonging to the same object motion phase are sorted. For each phase an equal number nₚᵣₒⱼ of projections is obtained (with t_{X-ray} being the duration of the complete C-arm sweep):

$${n}_{proj} = \frac{{f}_{X \text{-} ray} \cdot {t}_{X \text{-} ray}}{{n}_{phases}} \qquad ( 2 )$$

From these projections a number of nₚₕₐₛₑₛ of 3D-RX reconstructions is obtained. The sorted projections, with the knowledge of their acquisition geometry and corrected for distortion, are used for 3D-RX reconstruction with a modified filtered backprojection Feldkamp algorithm (cf. Feldkamp L. A., Davis L. C. and Kress J. W.: “Practical cone-beam algorithms”, J. Opt. Soc. Am. 6, 612-19, 1984). The set of nₚₕₐₛₑₛ reconstructions each have their own phase in the motion cycle and together form a dynamic 3D image.

The method for the generation of 3D images of a moving joint can be summarized as follows:

Data acquisition steps:

1. The patient is positioned on the patient table and the device 20 for measuring the flexion of the joint to be imaged is attached to the joint.

2. The patient moves the joint repeatedly in a periodic manner (alternatively, the joint of the patient may be moved passively by some device, cf. FIG. 2 below).

3. The X-ray system 10 starts its rotation around the joint and starts taking the 2D projection images.

4. Whenever an image is available (about 25-30 Hz) it is sent together with the current position of the C-arm to the workstation 31.

5. The workstation immediately reads out the corresponding angle of the flexion measurement system.

6. Steps 4 and 5 are repeated until enough data is sampled.

Post-processing steps:

1. Now a set of several hundred images is available each labeled with the corresponding C-arm position and joint flexion.

2. This image set is split into subsets of images. Each image in this subset belongs to the same phase of the movement.

3. For each subset a three-dimensional image of the joint is reconstructed.

4. The result of the procedure is a series of 3D images of the joint, each of them for a different phase of movement. This series can be displayed as a movie or analyzed in detail on a medical workstation.

The monitoring device for determining the flexion of the joint movement may be implemented in several ways:

A position measurement system (electromagnetic or optical) can be used to determine the position of at least two trackers attached to the fore-limb and the upper-limb.

An angle detector (goniometer) can be attached to the joint measuring the angles of interest (a single angle for the elbow joint, two angles for the wrist, three angles for the shoulder).

An X-ray device can be used to determine the angles. Under certain conditions the relevant angles might be determined from the X-ray images of a rotational run.

The limb can be attached to an external device actively guiding the joint motion in a periodical manner. This device can be synchronized with the X-ray system allowing to acquire projection images in defined phases of the movement (see description of FIG. 2 below).

In a typical realization of the system of FIG. 1, a BV Pulsera (Philips Medical systems, Best, The Netherlands) may be used for the image acquisition. This system is modified to make a motorized rotation over 200 degrees of rotational angle Φ. The system is able to make pulsed fluoroscopic images with different acquisition speeds (1-25 fps, with a maximum of total 375 images) and pulse length (8-13 ms). The images are sent to a modified 3D-RX release 3.2 workstation. Beforehand calibration of distortion and imaging geometry is done. The workstation reconstructs from all projections a 3D data set of 256·256·256 voxel in a volume of 18·18·18 cm³. The X-ray acquisition timing is monitored with the video output of the trolley. The internal X-ray generator synchronizes the pulses with the video when the acquisition is started.

FIG. 2 schematically shows an alternative realization of a monitoring device 120 which is adapted to perform a forced movement of about 40 degrees up and down of a wrist joint 2. The apparatus 120 comprises a static support 123 on which the forearm of a patient may rest and a movable support 126 on which the hand of the patient may rests. The movable support 126 is hinged about an axis 125, wherein periodic oscillations x_{obj} about said axis can be generated by a driver rod 124. The rod 124 is eccentrically fixed to a disk 122 which is rotated by a DC motor 121. The DC motor with speed reduction is controlled with a negative feedback system to ensure constant motion. The cycle of the hand is tracked with a flag sensor, the flag for example being fixed to disk 122. The flag signal generated by this sensor is used for synchronization with the 3D-RX system. The video sync and the flag signal are displayed on the oscilloscope for synchronization. After synchronization the acquisition of the projections is started. Next the projections are sorted and reconstructed as described above.

As the right part of the device of FIG. 2 is situated in the X-ray cone, it is wrought in low X-ray density plastic.

The dynamic imaging of the wrist and of other joints for diagnosis is of great help for assessing of functional disorders. Current imaging systems are not suitable for dynamic 3D imaging of the wrist. Therefore the new method called 4D-RX uses a state of the art mobile rotational X-ray system together with a device suitable for synchronized cyclic movement of the wrist. The presented method gives better insight in dynamic motion patterns than 2D video fluoroscopy. The three dimensional character and potential for quantitative measurements make it an excellent investigational device for diagnosis of wrist disorders. State of the art animated CT imaging of the carpals lacks of representing the true clinical dynamic situation, hysteresis and acute changes in motion patterns will not be revealed. The 4D-RX system is able to image a full dynamic motion pattern of the wrist.

X-ray pulse length and number of input projections were examined with a bullet and rod phantom. A number of approximate 40 projections is necessary for adequate reconstruction. In the current system there is a trade-off between the number of phases for which a 3D image is reconstructed (i.e. the temporal resolution of the motion) and image quality. An increasing X-ray pulse length showed a decrease in noise. Moreover there is overall absence of motion blur. Although noise and sampling is sub-optimal anatomical structures were clearly recognizable in a wrist experiment. Electronic synchronization of the system and a larger number of input projections are settings that may improve image quality.

Finally it is pointed out that in the present application the term “comprising” does not exclude other elements or steps, that “a” or “an” does not exclude a plurality, and that a single processor or other unit may fulfill the functions of several means. The invention resides in each and every novel characteristic feature and each and every combination of characteristic features. Moreover, reference signs in the claims shall not be construed as limiting their scope.

1. System for the generation of 3D images of a joint (1, 2) in different phases of its motion, comprising
a) a rotational X-ray device (10) that is adapted to generate a series of projections of the joint (1, 2) from different directions while the joint (1, 2) is moving;
b) a monitoring device (20, 120) that is adapted to provide information on the current motion phase of the joint (1, 2) during its movement;
c) an image processing device (30) for subdividing said series of projections into classes corresponding to different motion phases of the joint (1, 2) and for reconstructing 3D images from the projections of each class.

2. The system according to claim 1, characterized in that the monitoring device comprises a position measuring system that is adapted to determine the spatial position and/or orientation of at least two markers on different segments of the joint.

3. The system according to claim 1, characterized in that the monitoring device comprises a goniometer (20) that can be attached to the joint (1).

4. The system according to claim 1, characterized in that the monitoring device comprises an imaging device (10) for generating images of the joint (1, 2) and an evaluation unit (30) for deriving the motion phase from said images.

5. The system according to claim 1, characterized in that the monitoring device comprises an apparatus (120) for forcing an externally prescribed movement on the joint (1, 2).

6. The system according to claim 1, characterized in that the movement of the joint (1, 2) is synchronized with the generation of projections by the X-ray device (10).

7. The system according to claim 1, characterized in that it comprises a display unit (32) for displaying the reconstructed 3D images, preferably comprising a film sequence.

8. A method for the generation of 3D images of a joint (1, 2) in different phases of its motion, comprising the following steps:
a) moving the joint (1, 2);
b) generating a series of X-ray projections of the joint (1, 2) during its movement from different directions;
c) determination of the current phase of the joint motion during step b);
d) classifying the projections of said series into classes corresponding to different determined phases of the joint motion and reconstructing a 3D image from the projections for each class.

9. The method according to claim 8, characterized in that the joint (1, 2) is actively moved in synchronization with the generation of X-ray projections.

10. The method according to claim 8, characterized in that the current phase of the joint motion is derived from the X-ray projections.
